(19) United States
(12) Patent Application Publication
(10) Pub. No.: US 2021/0376404 A1
(43) Pub. Date: Dec. 2, 2021

(54) SECONDARY BATTERY

(71) Applicant: HONDA MOTOR CO., LTD., Tokyo (JP)

(72) Inventors: Kiyoshi TANAAMI, Saitama (JP); Shintaro AOYAGI, Saitama (JP); Yuji ISOGAI, Saitama (JP)

(21) Appl. No.: 17/332,977

(22) Filed: May 27, 2021

(30) Foreign Application Priority Data
Jun. 1, 2020 (JP) 2020-095591

(51) Int. Cl. H01M 10/653; H01M 10/613; H01M 4/64; H01M 10/0525; H01M 10/654

(52) U.S. Cl. CPC H01M 10/653; H01M 10/613; H01M 10/654; H01M 10/0525; H01M 4/64

(57) ABSTRACT

To provide a battery cell structure capable of improving heat dissipation without degradation of an energy density and an obstacle to size reduction while an electrode layer of a battery cell has sufficient heat transfer properties. The present invention relates to a cell structure including a positive/negative electrode formed in such a manner that a conductive base member having a three-dimensional structure contains an electrode active material and a collector formed continuously to the positive/negative electrode. One surface of the collector is formed continuously in a longitudinal direction of the positive/negative electrode (across a large area), and the other surface of the collector is exposed in a longitudinal direction of the cell structure (across a large area).

This application is based on and claims the benefit of priority from Japanese Patent Application 2020-095591 filed on 1 Jun. 2020, the content of which is incorporated herein by reference.

### BACKGROUND OF THE INVENTION

### Field of the Invention

The present invention relates to a secondary battery such as a lithium ion battery, and particularly relates to a cell structure of a secondary battery improving heat dissipation in the secondary battery.

### Related Art

Typically, a lithium ion battery has been widely used as a secondary battery having a high energy density. The secondary battery such as the lithium ion battery includes a cell structure having a collector made of metal foil, a positive/negative electrode configured such that a compounding agent containing an electrode active material is applied to a surface of the collector, and an electrolyte interposed between the positive and negative electrodes.

For developing an effective function and ensuring durability such as cycle properties in the secondary battery such as the lithium ion battery, it is important to maintain a battery cell within a predetermined temperature range. However, the battery cell might be at a high temperature due to heat generated upon charging/discharging, and needs to have a cooling or heat dissipation structure. Particularly, in a case where the collector is decreased in thickness due to a demand for increasing the thickness and density of the electrode in association with an increase in an energy density and a demand for cell size reduction, there are problems that heat dissipation tends to be degraded and heat tends to be accumulated in the battery.

For this reason, Japanese Unexamined Patent Application, Publication No. 2017-212111 proposes that a positive electrode material layer contains a carbon fibrous material such as a carbon nanotube to enhance a thermal conductivity, improve heat dissipation, and reduce accumulated heat even in a case where a collector is decreased in thickness.
Patent Document 1: Japanese Unexamined Patent Application, Publication No. 2017-212111

### SUMMARY OF THE INVENTION

However, in a typical battery cell structure as in Japanese Unexamined Patent Application, Publication No. 2017-212111, heat is dissipated from an electrode layer of a battery cell through a collection tab of the collector. For this reason, as long as heat dissipation of the collection tab of the collector is not enhanced, even in the structure for reducing accumulated heat in the electrode layer of the battery cell as in Japanese Unexamined Patent Application, Publication No. 2017-212111, such an effect cannot be sufficiently produced. That is, heat collected by heat transfer in the battery cell is concentrated on the collection tab, and the advantage of the heat dissipation effect is degraded. An uncoated region with no compounding agent is formed at the electrode layer, and the collection tab is welded to such a region. For this reason, a resistance increases. In a case where the size of the collection tab is increased for improving the heat dissipation of the collection tab, there are problems that an energy density is degraded and an obstacle to size reduction is caused.

The present invention has been made in view of the above-described situation, and an object of the present invention is to provide a battery cell structure capable of improving heat dissipation without degradation of an energy density and an obstacle to size reduction while an electrode layer of a battery cell has sufficient heat transfer properties.

For solving the above-described problems, the secondary battery of the present invention includes a cell structure having a positive/negative electrode formed in such a manner that a conductive base member having a three-dimensional structure contains an electrode active material and a collector formed continuously to the positive/negative electrode. One surface of the collector is formed continuously in a longitudinal direction of the positive/negative electrode formed in such a manner that the conductive base member contains the electrode active material (across a large area), and the other surface of the collector is exposed in a longitudinal direction of the cell structure (across a large area).

One surface of the collector is formed continuously in the longitudinal direction of the positive/negative electrode formed in such a manner that the conductive base member contains the electrode active material (across the large area), and the other surface of the collector is exposed in the longitudinal direction of the cell structure. With this configuration, the area of contact between the positive/negative electrode configured such that the conductive base member contains the electrode active material and the collector increases, and a heat dissipation area increases. Thus, heat dissipation can be significantly improved. This structure can be assumed as one with no collection tab because the collector is integrated with a cell exterior body. Thus, there are no problems such as degradation of an energy density due to heat collection to the collection tab and an increase in the size of the collection tab.

In the secondary battery of the present invention, the positive/negative electrode in the cell structure may have a multilayer structure or a winding structure. The secondary battery of the present invention is characterized in that the positive/negative electrode has a series structure in a direction to the collector. It may only be required that the secondary battery of the present invention has a structure capable of increasing the area of contact between the positive/negative electrode and the collector, and in terms of the form of the positive/negative electrode structure, the present invention is also applicable to any of the multilayer structure and the winding structure. The positive/negative electrode has the series structure so that electrons can be smoothly moved from the stacked positive/negative electrode to the collector and power generation properties can be improved. In addition, the thermal conductivity of the entirety of the cell can be improved, and heat dissipation properties of the cell can be improved.

In the second battery of the present invention, the cell structure may be a laminated cell or a can cell. It may only be required that the secondary battery of the present invention is configured such that the cell exterior body and the collector are integrated together to increase the area of contact between the positive/negative electrode and the collector, and the present invention is also applicable to the laminated cell or the can cell as the cell structure.

The secondary battery of the present invention may be a secondary battery having an electrolytic solution or a secondary battery having a solid electrolyte. It may only be required that the secondary battery of the present invention has the structure capable of increasing the area of contact between the positive/negative electrode and the collector, and in terms of the form of the secondary battery, the present invention is also applicable to the secondary battery having the electrolytic solution or the secondary battery having the solid electrolyte.

The secondary battery of the present invention is also applicable to a module configured such that a plurality of secondary batteries is aligned in electrical connection with each other. According to the structure of the collector of the present invention, a bus bar essential for typical module formation is not necessary, and a series design can be achieved by surface contact of both cell surfaces. Thus, a resistance component due to the bus bar can be eliminated, and a low-resistance module design having high heat dissipation can be achieved. Moreover, size and weight reduction can also be achieved.

In the second battery of the present invention, the conductive base member of the positive/negative electrode is made of foam metal having a three-dimensional structure. The metal foam has the mesh-shaped three-dimensional structure, and has a large surface area. The foam porous body made of the metal is used as the conductive base member of the positive/negative electrode so that the mesh-shaped structure can be filled with an electrode compounding agent containing an electrode active material and an active material amount per unit area of an electrode layer can be increased. In addition, the volumetric energy density of the lithium ion secondary battery can be improved.

Since the collection tab is not necessary, the present invention can prevent, as additional effects, durability deterioration due to uneven welding at a step welded portion between the collection tab and the exterior body (a laminated film), can reduce liquid leakage and gas leakage due to such durability deterioration, and can improve pressure resistance to internal gas.

Since the collection tab is not necessary, the present invention can eliminate, as other additional effects, the necessity of taking the width of the collection tab into consideration, and can narrow a width between battery cells. Thus, a design can be freely made from one with a small width to one with a great width. The degree of freedom in the design of the shape of the battery cell is increased so that a battery can be produced in a shape corresponding to an application to be applied.

As described above, the present invention has an advantageous effect that the heat dissipation can be significantly improved because one surface of the collector is formed continuously in the longitudinal direction of the positive/negative electrode, which is configured such that the conductive base member contains the electrode active material, across the large contact area and the other surface of the collector is exposed in the longitudinal direction of the cell structure across the large area. The present invention produces the above-described additional effects.

### BRIEF DESCRIPTION OF THE DRAWINGS

FIG. 1 is a view showing a cell structure of a battery cell of a typical secondary battery;

FIG. 2 is a view showing a cell structure of a battery cell of a secondary battery of the present invention;

FIG. 3 is a view showing a cell structure of a secondary battery of the present invention in which a stack in a battery cell has a winding structure;

FIG. 4 is a graph comparing an energy density between the typical cell structure and the cell structure of the present invention;

FIG. 5 is a graph showing measurement results of thermal conductivities of multilayer cells of a Comparative Example and Examples 1 to 3;

FIG. 6 is a graph showing measurement results of electrical resistances of the multilayer cells of the Comparative Example and Examples 1 to 3 upon discharging;

FIG. 7 is a graph showing measurement results of the electrical resistances of the multilayer cells of the Comparative Example and Examples 1 to 3 upon charging;

FIG. 8 is a graph showing measurement results of capacity retention rates of the multilayer cells of the Comparative Example and Examples 1 to 3; and

FIG. 9 is a graph showing measurement results of resistance change rates of the multilayer cells of the Comparative Example and Examples 1 to 3.

### DETAILED DESCRIPTION OF THE INVENTION

Hereinafter, an embodiment of the present invention will be described with reference to the drawings.

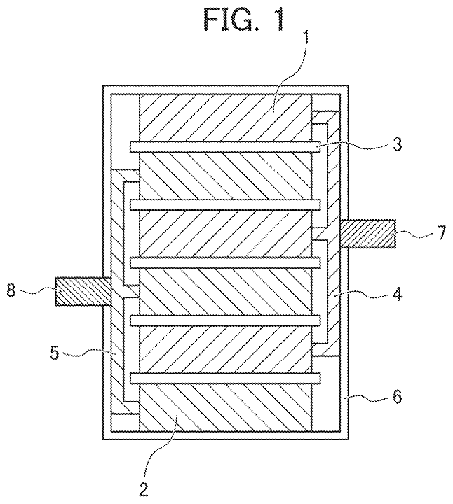

FIG. 1 shows a cell structure of a battery cell of a typical secondary battery. A reference numeral 1 indicates a positive electrode, a reference numeral 2 indicates a negative electrode, and a reference numeral 3 indicates a separator. The positive electrodes and the negative electrodes are stacked on each other in the order of the positive electrode and the negative electrode from above with each separator being interposed between the positive electrode and the negative electrode. A reference numeral 4 indicates a positive electrode collection member that collects power from each of the stacked positive electrodes, and a reference numeral 5 indicates a negative electrode collection member that collects power from each of the stacked negative electrodes. A reference numeral 6 indicates an exterior body formed of, e.g., a laminated film, and entirely covers the stack of the positive electrodes 1, the separators 3, and the negative electrodes 2, the positive electrode collection member 4, and the negative electrode collection member 5 to form a battery cell. In the battery cell of the typical secondary battery, a positive-electrode-side collection tab 7 and a negative-electrode-side collection tab 8 are provided as members for finally taking the battery out of the positive electrode collection member 4 and the negative electrode collection member 5.

In the cell structure of the typical secondary battery, the exterior body contacting the positive electrodes 1 and the negative electrodes 2, such as the laminated film, has a low thermal conductivity, and not much heat is dissipated from the positive electrodes 1 and the negative electrodes 2 through the exterior body. For this reason, much heat is dissipated through the positive electrode collection member 4, the negative electrode collection member 5, the positive-electrode-side collection tab 7, and the negative-electrode-side collection tab 8. In this structure, heat transferred from the positive electrodes 1 and the negative electrodes 2 through the positive electrode collection member 4 and the negative electrode collection member 5 is concentrated on the thin collection tabs 7, 8, and sufficient heat dissipation cannot be achieved. In a case where a collection tab size is increased to improve the heat dissipation, an energy density decreases and a problem of an obstacle to size reduction is caused.

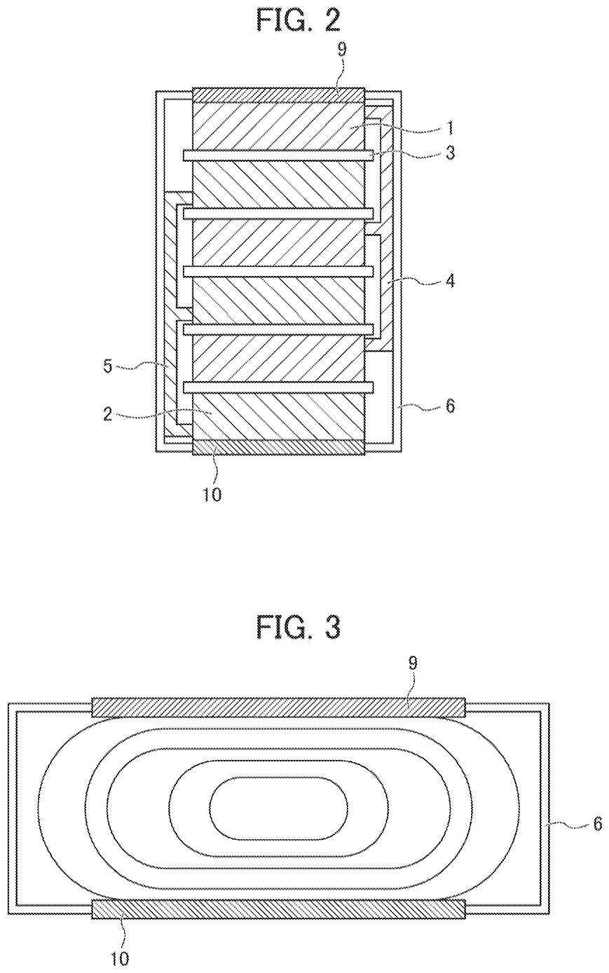

FIG. 2 shows a cell structure of a battery cell of a secondary battery of the present invention. Configurations of a positive electrode 1, a negative electrode 2, a separator 3, a positive electrode collection member 4, a negative electrode collection member 5, and an exterior body 6 are not different from those of FIG. 1 of the typical cell structure. In the cell structure of the battery cell of the secondary battery of the present invention, the collection tabs 7, 8 as the portions for finally taking out the battery in the typical cell structure are omitted. Instead, a positive-electrode-side collector 9 and a negative-electrode-side collector 10 are, outside the positive electrode 1 and the negative electrode 2 on the outermost peripheral side, provided such that surfaces on that one side contact the positive electrode 1 and the negative electrode 2 across wide areas. The other side surfaces are exposed to the outside of the exterior body 6 across wide areas.

With this configuration, the area of contact between each of the positive electrode 1 and the negative electrode 2 and the collector as a heat dissipation member is significantly expanded so that heat dissipation can be significantly improved. Such expansion of the contact area also decreases an electrical resistance between the positive electrode 1 and the positive-electrode-side collector 9 and an electrical resistance between the negative electrode 2 and the negative-electrode-side collector 10, and also improves electrical output performance. Further, the collection tabs 7, 8 in the typical cell structure are omitted, and therefore, a welded portion between the collection tab 7, 8 and the exterior body 6 is eliminated. Thus, durability deterioration due to uneven welding can be reduced, and durability can be improved.

FIG. 3 shows a cell structure in which the stack of positive electrodes 1, negative electrodes 2, and separators 3 has a winding structure. The winding structure of the stack is well known, and FIG. 3 shows the winding structure in a simple manner. In the winding structure, there are cases where no positive electrode collection member 4 and no negative electrode collection member 5 are necessary, such as a case where all of the positive electrodes 1, the negative electrodes 2, and the separators 3 are connected to each other. An exterior body 6, a positive-electrode-side collector 9, and a negative-electrode-side collector 10 are the same as those of the cell structure of FIG. 2. As shown in FIG. 3, portions contacting the positive-electrode-side collector 9 and the negative-electrode-side collector 10 across wide areas are partially formed in the winding structure of the stack so that the cell structure of the present invention can be applied to such a winding structure.

The cell structure of the battery cell of the secondary battery of the present invention can be implemented in various other forms. The positive and negative electrodes may form a series structure. Alternatively, the cell structure may be a laminated cell or a can cell. Alternatively, the type of secondary battery may be a secondary battery having an electrolytic solution or a secondary battery having a solid electrolyte.

The present invention can also be applied to a module configured such that a plurality of secondary batteries is aligned in electrical connection with each other. According to the structure of the collector of the present invention, bus bars for connecting the collection tabs 7, 8 which are essential for typical module formation are not necessary, and a series design can be achieved by surface contact of both cell surfaces. Thus, a resistance component due to the bus bar can be eliminated, and a low-resistance module design having high heat dissipation can be achieved. Accordingly, the number of components can be reduced, leading to size and weight reduction.

Next, the composition of the material of each member of the cell structure for the embodiment of the present invention will be described.

### <Positive Electrode>

The positive electrode 1 is formed in such a manner that a conductive base member having a three-dimensional framework made of foam metal is filled with a compounding agent. For the foam metal, Al is used as a material, a porosity is about 95%, the number of cells is 46 to 50/inch, a pore size is about 0.5 mm, and a specific surface area is about 5000 m2/m3. The compounding agent includes a positive electrode active material, an auxiliary agent, and a binder. As the positive electrode active material, a ternary positive electrode active material of NCM represented by Li(NixCoyMnz)O2 is used. As Li(NixCoyMnz)O2, those with xyz ratios of x:y:z=1:1:1, 1:4:1, 5:3:2, 6:2:2, and 8:1:1 are used. As other alternatives, a ternary positive electrode active material represented by LiNi0.8Co0.15Al0.0502, LiCoO3, LiNiO3, LiMn2O4, LiNi0.5Mn1.5O4, LiFePO4, vanadium-based materials, sulfur-based-materials, solid solution-based materials (lithium-excess materials, sodium-excess materials, and potassium-excess materials), carbon-based materials, organic materials, etc. are also used. As the auxiliary agent of the positive electrode 1, acetylene black (AB), Ketjen black (KB), furnace black (FB), thermal black, lamp black, channel black, roller black, disc black, carbon black (CB), a carbon fiber (e.g., a vapor-grown carbon fiber VGCF (the registered trademark)), a carbon nanotube (CNT), a carbon nanohorn, graphite, graphene, glassy carbon, amorphous carbon, etc. are used. Polyvinylidene fluoride (PVDF), polytetrafluoroethylene (PTFE), polyacrylic, alginic acid, etc. are used as the binder. A single type may be used alone, or two or more types may be used in combination. The compounding agent is formed such that the composition ratio of the active material, the auxiliary agent, and the binder is within a range of the active material:the auxiliary agent:the binder=80 to 99:0.5 to 19.5:0.5 to 19.5 (mixed such that the total of these three components is 100).

### <Negative Electrode>

The negative electrode 2 is formed in such a manner that a conductive base member having a three-dimensional framework made of foam metal is filled with a compounding agent. For the foam metal, Cu is used as a material, a porosity is about 95%, the number of cells is 46 to 50/inch, a pore size is about 0.5 mm, and a specific surface area is about 5000 m2/m3. A thickness is about 1.0 mm. The compounding agent includes a negative electrode active material, an auxiliary agent, and a binder. As the negative electrode active material, black lead (graphite) such as artificial graphite or natural graphite, hard carbon, soft carbon, or a silicon-based material such as Si metal or a Si compound is used. The auxiliary agent of the negative electrode 2 includes, for example, acetylene black (AB), Ketjen black (KB), furnace black (FB), thermal black, lamp black, channel black, roller black, disc black, carbon black (CB), a carbon fiber (e.g., a vapor-grown carbon fiber VGCF (the registered trademark)), a carbon nanotube (CNT), a carbon nanohorn, graphite, graphene, glassy carbon, and amorphous carbon, and one type or two or more types of these components are used. Sodium carboxymethyl cellulose, styrene-butadiene rubber, polyvinylidene fluoride, or sodium polyacrylate is used as the binder. The compounding agent is formed such that the composition ratio of the active material, the auxiliary agent, and the binder is within a range of the active material:the auxiliary agent:the binder=80 to 99.5:0 to 10:0.5 to 20 (mixed such that the total of these three components is 100).

### <Cell Structure>

Other cell components included in the stack of the cell structure are the separator 3, an electrolyte, and an electrolyte solvent. As the material of the separator 3, a polyethylene microporous film, a polypropylene microporous film, glass non-woven fabric, aramid non-woven fabric, a polyimide microporous film, a polyolefin microporous film, etc. are used. At least one or more selected from a group consisting of lithium hexafluorophosphate (LiPF₆), lithium perchlorate (LiClO₄), lithium tetrafluoroborate (LiBF₄), lithium trifluoromethanesulfonate (LiCF₃SO₄), lithium bis(trifluoro methanesulfonyl)imide (LiN(SO₂CF₃)₂), lithium bis(pentafluoroethanesulfonyl)imide (LiN(SO₂C₂F₅)₂), lithium bis(oxalate)borate (LiBCaOg), etc. can be used as the electrolyte, or two or more types can be used in combination. At least one selected from a group consisting of propylene carbonate (PC), ethylene carbonate (EC), dimethyl carbonate (DMC), diethyl carbonate (DEC), ethyl methyl carbonate (EMC), γ-butyrolactone (GBL), methyl-γ-butyrolactone, dimethoxymethane (DMM), dimethoxyethane (DME), vinylene carbonate (VC), vinylethylene carbonate (VEC), fluoroethylene carbonate (FEC), and ethylene sulfite (ES) can be used as the electrolyte solvent, or two or more types may be used in combination.

### <Collector>

The positive-electrode-side collector 9 and the negative-electrode-side collector 10 are collectors made of metal foil. The positive-electrode-side collector 9 and the negative-electrode-side collector 10 are arranged at the outermost periphery of the positive electrode and the negative electrode, and are integrated with the exterior body 6. Outer surfaces of the positive-electrode-side collector 9 and the negative-electrode-side collector 10 are exposed to external air. Al is used as a positive-electrode-side material, and Cu and Ni are used as a negative-electrode-side material. Note that the positive electrode collection member 4 and the negative electrode collection member 5 for collecting power from each stack of the positive and negative electrodes to the positive-electrode-side collector 9 and the negative-electrode-side collector 10 are made of foam metal. The foam metal for the positive electrode collection member 4 and the negative electrode collection member 5 is not filled with a compounding agent.

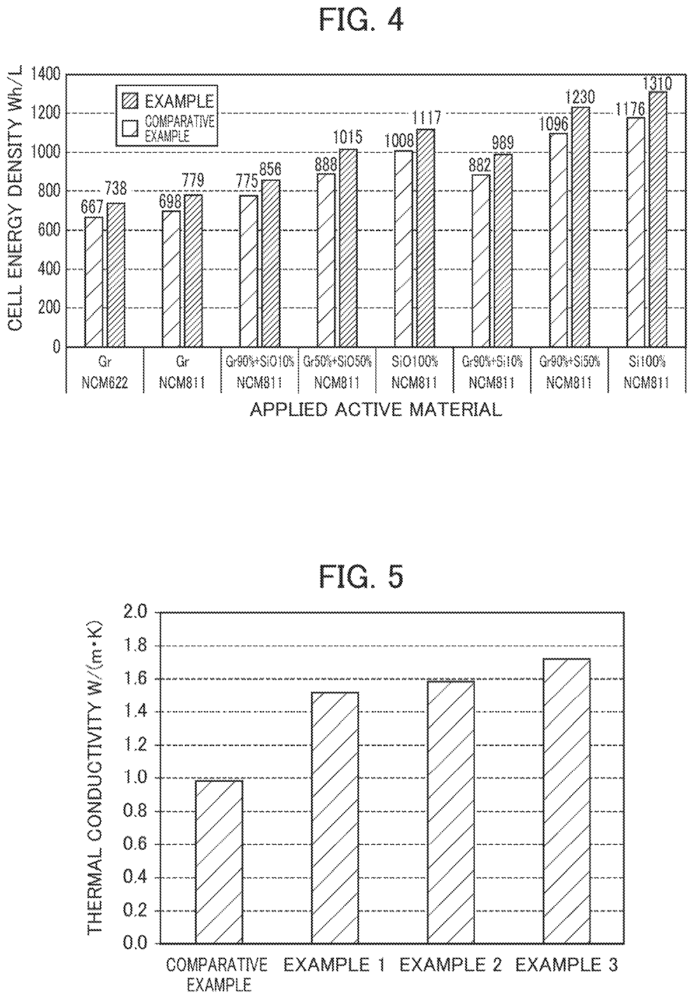

A graph comparing the energy density between the cell structure of the typical secondary battery and the cell structure of the secondary battery of the present invention is shown for different positive and negative electrode active materials in FIG. 4. Each combination between the positive and negative electrode active materials is compared, and these combinations include a combination of a positive electrode that is NCM622 (a ternary active material represented by Li(NixCoyMnz)O2 and having an xyz ratio of 6:2:2, the same applies below) and a negative electrode that is Gr (graphite (black lead)), a combination of a positive electrode that is NCM811 and a negative electrode that is Gr, a combination of a positive electrode that is NCM811 and a negative electrode that is 90% by mass of Gr and 10% by mass of SiO, a combination of a positive electrode that is NCM811 and a negative electrode that is 50% by mass of Gr and 50% by mass of SiO, a combination of a positive electrode that is NCM811 and a negative electrode that is SiO, a combination of a positive electrode that is NCM811 and a negative electrode that is 90% by mass of Gr and 10% by mass of Si, a combination of a positive electrode that is NCM811 and a negative electrode that is 50% by mass of Gr and 50% by mass of Si, and a combination of a positive electrode that is NCM811 and a negative electrode that Si.

Any combination between the positive and negative electrodes shows that the cell structure of the present invention increases the energy density by 10 to 15% as compared to the typical cell structure. It can be assumed that this is because the collection tabs in the typical cell structure are omitted. In terms of the materials of the positive and negative electrodes, the positive electrode has a higher energy density in the case of NCM811 than in the case of NCM622, and exhibits excellent collection performance in the case of having a higher percentage of nickel. The negative electrode has a higher energy density in the case of a higher percentage of Si or SiO with respect to Gr.

Next, for the cell structure of the typical secondary battery with the collection tabs (a normal tab: a Comparative Example) and the cell structure of the present invention with the collectors integrated with the exterior body (a laminated film integrated type: Examples), each item of a thermal conductivity, a resistance upon discharging, a resistance upon charging, a capacity retention rate, and a resistance change rate was measured and compared. Each collector (collection tab) is made of foam metal, and as comparison targets, three laminated film integrated types of the Examples (Examples 1 to 3) of the present invention were measured and compared for different average particle sizes of the foam metal.

The main configuration and energy density (Wh/L) of each battery cell of the Comparative Example and Examples 1 to 3 are shown in Table 1 below.

TABLE 1

| | Comparative | | | |
|---|---|---|---|---|
| | Example | Example 1 | Example 2 | Example 3 |
| Shape of | normal tab | laminated | laminated | laminated |
| collector | | film | film | film |
| (tab) | | integrated | integrated | integrated |
| | | type | type | type |
| Conductive | foam metal | foam metal | foam metal | foam metal |
| base member of | | | | |
| positive/negative | | | | |
| electrode | | | | |
| Form of | multilayer | multilayer | multilayer | multilayer |
| battery cell | cell | cell | cell | cell |
| Positive | NCM523 | NCM523 | NCM523 | NCM523 |
| electrode | | | | |
| active | | | | |
| material | | | | |
| Average | 10 | 10 | 7 | 5 |
| particle size | | | | |
| μm | | | | |
| Energy density | 360.6 | 390.3 | 399.1 | 396.3 |
| Wh/L | | | | |

As shown in Table 1, the shape of the collector/collection tab is a typical normal collection tab (the normal tab) in the Comparative Example, whereas the shape in Examples 1 to 3 is a type (the laminated film integrated type) integrated with the exterior body (the laminated film). The material of the conductive base member of the positive/negative electrode is foam metal in any of the Comparative Example and Examples 1 to 3. The form of the battery cell is a multilayer cell form in any of the Comparative Example and Examples 1 to 3. NCM523 is used as the positive electrode active material in any of the Comparative Example and Examples 1 to 3. The average particle size is 10 μm in the Comparative Example and Example 1, is 7 μm in Example 2, and is 5 μm in Example 3.

Thus, a difference in each measurement item due to the structure of the collector/collection tab, i.e., a difference due to whether the structure employs the collectors integrated with the exterior body as in the present invention or the collection tabs as in the typical example, can be read by comparing the Comparative Example with Example 1 where the average particle size of the positive electrode active material is the same as that of the Comparative Example. Moreover, a difference in each measurement item due to the average particle size of the positive electrode active material can be read by comparing Examples 1 to 3.

Table 1 shows that measurement results of the energy density Wh/L in the Comparative Example and Examples 1 to 3 are 360.6 in the Comparative Example, 390.3 in Example 1, 399.1 in Example 2, and 396.3 in Example 3. These measurement results show that the battery cell employing the collectors integrated with the exterior body as in the present invention is, in terms of the energy density, higher than the battery cell employing the structure with the collection tabs as in the typical example by about 8%, and this trend is similar to the trend of comparison between the cell structure of the present invention and the typical cell structure in the above-described energy density measurement example. In terms of a difference due to the average particle size of the foam metal as the material of the collector, the trend that the energy density is lowest in a case where the average particle size is a largest value of 10 μm (Example 1) and increases, as a whole, as the average particle size decreases can be read. However, the energy density is almost the same between the case of an average particle size of 7 μm (Example 2) and the case of an average particle size of 5 μm (Example 3), or rather, is higher in the case of an average particle size of 7 μm (Example 2) than in the case of an average particle size of 5 μm (Example 3). The energy density does not always increase as the average particle size decreases.

Next, the thermal conductivity was measured for the multilayer cells of the Comparative Example and Examples 1 to 3. A measurement method is as follows. A measured heat flow (a heat quantity q) is applied to a sample of each multilayer cell as a measurement target, and in this state, the battery is left until the steady state is reached. At this point, a temperature difference Δθ between both end surfaces of the sample is measured. The Fourier's law is applied to the heat quantity q of the measured heat flow, the temperature difference Δθ between both end surfaces of the sample, and a sample thickness Δx, and a thermal conductivity A is obtained from Expression (1) below.

[Expression 1]

Λ=(q/Δθ)×Δx Expression (1)

Note that in measurement of the thermal conductivity, a temperature of the measurement environment is about 40° C. (a heating temperature: about 90° C., a cooling temperature: about 15° C.), and a load on the sample is a joint interface pressure of 100 kPa.

Measurement results of the thermal conductivities of the multilayer cells of the Comparative Example and Examples 1 to 3 are shown in FIG. 5. FIG. 5 shows that the thermal conductivity is higher in Examples 1 to 3 than in the Comparative Example by equal to or higher than 50% to 70%. The (laminated film integrated type) structure employing the collectors integrated with the exterior body as in Examples 1 to 3 significantly increases the thermal conductivity across the entirety of the multilayer cell, and heat generated at the positive/negative electrode is promptly diffused to the collector. That is, it has been confirmed that the heat dissipation is significantly enhanced by the (laminated film integrated type) structure employing the collectors integrated with the exterior body as in the present invention. The thermal conductivity is higher in the order of Example 3, Example 2, and Example 1. Thus, a relationship between the average particle size of the positive electrode active material and the thermal conductivity can be read, in which the thermal conductivity increases as the average particle size of the active material decreases.

Next, the electrical resistance upon each respective discharging and charging was measured for the multilayer cells of the Comparative Example and Examples 1 to 3.

### [Initial Cell Resistance]

After measurement of an initial discharge capacity, a lithium ion secondary battery was adjusted to a charge level (the state of charge (SOC)) of 50%. Next, discharging was performed with each set current value for 10 seconds, and voltages upon discharging for 0.1 seconds, 1 second, and 10 seconds were measured. The set current values were 0.3 C, 0.5 C, 0.75 C, 1.0 C, 1.5 C, 2.0 C, and 2.5 C. The voltage at each point of time was plotted for each current value, the horizontal axis being the current value and the vertical axis being the voltage. The slope of such a plotted graph was taken as a resistance value. A resistance value at 10 seconds was defined as an overall resistance value, a resistance value (0.1-sec DCR) at 0.1 seconds was defined as an electronic resistance, a resistance value ((1-0.1)-sec DCR) at 0.1 seconds to 1 second was defined as a reaction resistance, and a resistance value ((10-1)-sec DCR) at 1 second to 10 seconds was defined as an ion diffusion resistance.

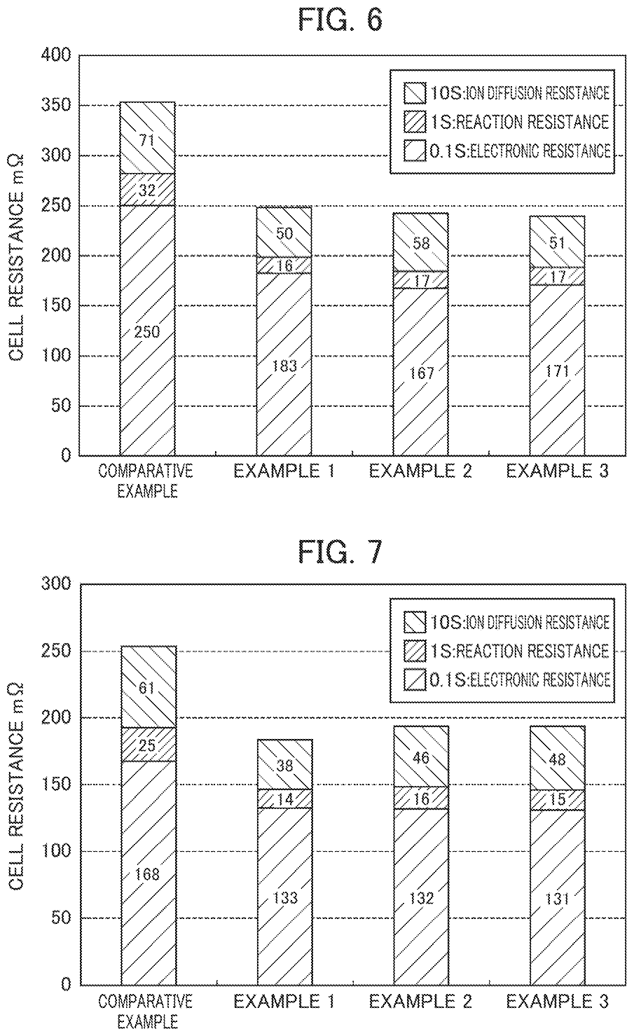

Measurement results of the electrical resistances of the multilayer cells of the Comparative Example and Examples 1 to 3 upon discharging are shown in FIG. 6, and measurement results of the electrical resistances of the multilayer cells of the Comparative Example and Examples 1 to 3 upon charging are shown in FIG. 7. From FIG. 6, it is read that the cell resistance across the entirety of the cell is, upon discharging, higher in the Comparative Example and Examples 1 to 3 by 104 to 114 mΩ (an increase rate of about 41 to 48%). From FIG. 7, it is read that the cell resistance across the entirety of the cell is, upon charging, higher in the Comparative Example than in Examples 1 to 3 by 60 to 69 mΩ (an increase rate of about 30 to 38%). The (laminated film integrated type) structure employing the collectors integrated with the exterior body as in Examples 1 to 3 significantly reduces the cell resistance in both of discharging and charging.

Focusing on an electronic resistance component, it is, from FIG. 6, read that the electronic resistance is higher in the Comparative Example than in Examples 1 to 3 by 67 to 83 mΩ upon discharging. From FIG. 7, it is read that the electronic resistance is higher in the Comparative Example than in Examples 1 to 3 by 35 to 37 mΩ upon charging. Particularly, a great effect of reducing the electronic resistance component is exhibited.

Next, the capacity retention rate was, as durability evaluation, measured by a 45° C. cycle test for the multilayer cells of the Comparative Example and Examples 1 to 3. A charge/discharge cycle durability test was performed as follows. The operation of performing constant voltage charging at a voltage of 4.2 V for five hours or until a current of 0.1 C after constant current charging has been performed at 0.6 C until 4.2 V in a thermostatic tank at 45° C., performing constant current discharging at a discharge rate of 0.6 C until 2.5 V after the battery has been left for 30 minutes, and leaving the battery for 30 minutes is taken as a single cycle, and such operation is repeated 200 times. After the end of 200 cycles, the thermostatic tank is brought to 25° C., and the battery is left for 24 hours in a state after 2.5 V discharging. Thereafter, a discharge capacity is measured as in measurement of the initial discharge capacity. Such operation is repeated for every 200 cycles, and measurement is performed until 600 cycles.

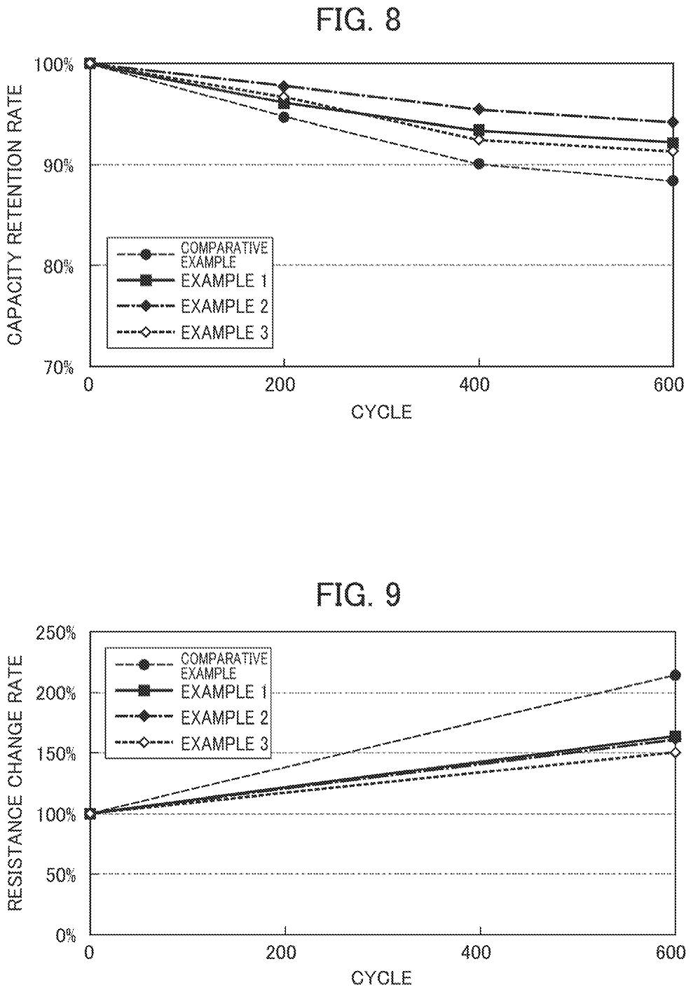

Measurement results of the capacity retention rates of the multilayer cells of the Comparative Example and Examples 1 to 3 by the 45° C. cycle test are shown in FIG. 8. FIG. 8 shows that the capacity retention rate is higher in any of the multilayer cells of Examples 1 to 3 than in the multilayer cell of the Comparative Example. Such a difference is obvious because the capacity retention rate drops to 90% at the time of 400 cycles and further drops thereafter in the Comparative Example and the capacity retention rate exceeds 90% even at 600 cycles in any of Examples 1 to 3.

Next, the resistance change rate was, as durability evaluation, measured by the 45° C. cycle test for the multilayer cells of the Comparative Example and Examples 1 to 3.

### [Initial Cell Resistance]

After measurement of the initial discharge capacity, the lithium ion secondary battery was adjusted to a charge level (the state of charge (SOC)) of 50%. Next, discharging was performed at a current value of 0.2 C for 10 seconds, and a voltage after a lapse of 10 seconds from discharging was measured. The voltage after a lapse of 10 seconds from discharging was plotted for a current at 0.2 C, the horizontal axis being the current value and the vertical axis being the voltage. Next, after the battery had been left for 10 minutes, auxiliary charging was performed such that the SOC returns to 50%, and the battery was further left for 10 minutes. Next, the above-described operation was performed for each of C-rates of 0.5 C, 1 C, 1.5 C, 2 C, and 2.5 C, and the voltage after a lapse of 10 seconds from discharging was plotted for a current at each C-rate. The slope of an approximation straight line obtained from each plot was taken as an initial cell resistance of the lithium ion secondary battery.

[Cell Resistance after Endurance]

After the end of 600 cycles, the charge level (the state of charge (SOC)) was adjusted to 50%, and a cell resistance after endurance was obtained by a method similar to that for measuring the initial cell resistance. The percentage (%) of the cell resistance after endurance (the cell resistance after 600 cycles) when the initial cell resistance is 100% was plotted, and FIG. 9 was produced.

Measurement results of the resistance change rates of the multilayer cells of the Comparative Example and Examples 1 to 3 by the 45° C. cycle test are shown in FIG. 9. FIG. 9 shows that the resistance change rate is lower in any of the multilayer cells of Examples 1 to 3 than in the multilayer cell of the Comparative Example. Such a difference is obvious because the cell resistance after endurance after 600 cycles increases to equal to or higher than 200% of the initial cell resistance in the Comparative Example and the cell resistance after endurance after 600 cycles is suppressed to about 150% of the initial cell resistance in any of Examples 1 to 3.

### EXPLANATION OF REFERENCE NUMERALS

1 Positive Electrode
2 Negative Electrode
3 Separator
4 Positive Electrode Collection Member
5 Negative Electrode Collection Member
6 Exterior Body (Laminated Film)
7 Positive-Electrode-Side Collection Tab
8 Negative-Electrode-Side Collection Tab
9 Positive-Electrode-Side Collector
10 Negative-Electrode-Side Collector

What is claimed is:

1. A secondary battery comprising:
a cell structure including a positive/negative electrode formed in such a manner that a conductive base member having a three-dimensional structure contains an electrode active material and a collector formed continuously to the positive/negative electrode,
wherein one surface of the collector is formed continuously in a longitudinal direction of the positive/negative electrode formed in such a manner that the conductive base member contains the electrode active material, and the other surface of the collector is exposed in a longitudinal direction of the cell structure.

2. The secondary battery according to claim 1, wherein the positive/negative electrode in the cell structure has a multilayer structure.

3. The secondary battery according to claim 1, wherein the positive/negative electrode in the cell structure has a winding structure.

4. The secondary battery according to claim 1, wherein in the cell structure, the positive/negative electrode has a series structure.

5. The secondary battery according to claim 1, wherein the cell structure is a laminated cell.

6. The secondary battery according to claim 1, wherein the cell structure is a can cell.

7. The secondary battery according to claim 1, wherein the secondary battery is a secondary battery having an electrolytic solution.

8. The secondary battery according to claim 1, wherein the secondary battery is a secondary battery having a solid electrolyte.

9. A secondary battery wherein a plurality of secondary batteries according to claim 1 is aligned in electrical connection with each other.

10. The secondary battery according to claim 1, wherein the conductive base member of the positive/negative electrode is made of foam metal.
